(19) United States
(12) Patent Application Publication
(10) Pub. No.: US 2012/0124066 A1
(43) Pub. Date: May 17, 2012

(54) SECS COMMUNICATION DEVICE AND SECS COMMUNICATION METHOD THEREOF

(75) Inventors: Chi Pin Chen, Hsinchu City (TW); Cheng Tso Tsai, Hsinchu County (TW); Tsai Hsu Lin, Taoyuan County (TW)

(73) Assignee: INDUSTRIAL TECHNOLOGY RESEARCH INSTITUTE, Hsinchu (TW)

(21) Appl. No.: 12/975,610

(22) Filed: Dec. 22, 2010

(30) Foreign Application Priority Data
Nov. 16, 2010 (TW) 099139393

(51) Int. Cl. G06F 17/30

(52) U.S. Cl. 707/756; 707/E17.044

(57) ABSTRACT

A SECS communication device and a SECS communication method thereof are presented. The SECS communication device includes a SECS-II message communication part, a translation part, and an information storage device access part, and further includes at least one set of data structure files and a message format file for defining a message content and a message format of a SECS-II message. The translation part decodes the SECS-II message into data in various information storage formats of an information storage device according to the data structure file and the message format file, and encodes the data in various information storage formats of the information storage device into the SECS-II message, so as to enable message exchange between an EAP and the information storage device through the SECS communication device. By applying the SECS communication method, cost of program development is reduced, and meanwhile, high system stability and industrial efficiency are achieved.

### CROSS-REFERENCE TO RELATED APPLICATIONS

This non-provisional application claims priority under 35 U.S.C. §119(a) on Patent Application No(s). 099139393 filed in Taiwan, R.O.C. on Nov. 16, 2010, the entire contents of which are hereby incorporated by reference.

### BACKGROUND OF THE INVENTION

1. Field of the Invention

The present invention relates to a Semiconductor Equipment and Material International (SEMI) Equipment Communication Standards (SECS) communication device and a SECS communication method thereof, and more particularly to a communication device and a communication method having a semiconductor equipment communication function by modifying a configuration file.

2. Related Art

In order to make the manufacturing process of semiconductor more efficient, semiconductor manufacturers control and manage semiconductor equipment through special communication protocols. For example, the Semiconductor Equipment and Material International (SEMI) formulated the SEMI Equipment Communication Standards (SECS), which have become communication standards employed in automated production and production data collection of equipment in the semiconductor industry.

Currently, in addition to the use in equipment in the semiconductor industry, the SECS is also widely applied in communication processing of automated production and production data collection of equipment in optoelectronics, light emitting diode (LED), and solar energy industries. Generally speaking, to enable equipment to have the SECS communication function, in research and development, program code writing, development, and test must be performed with reference to specs and SECS communication specification documents to be carried out that are provided by the customer. Afterwards, the equipment has the SECS communication function meeting the requirements of the customer.

However, such research and development method spends a lot of time, money, and efforts on system development and test, and also requires programmers having program development capability and professional knowledge and practical experience in SECS. Secondly, a communication program developed through program code writing has potential errors in the initial stage, thus affecting the stability of production operation of the equipment. The developed SECS communication program also does not have sufficient extensibility and flexibility. That is to say, the subsequent extension and modification of the SECS communication function is not easy, and the research and development personnel must modify the program codes of the communication program to achieve the purpose of extending or modifying the SECS communication function.

Based on the above reasons, it is currently an urgent issue for persons in the art to overcome the disadvantages and inconvenience in the conventional development of the SECS communication program through program code writing.

### SUMMARY

Accordingly, the present invention is a SECS communication device and a SECS communication method thereof, for solving the problem in the prior art. According to an embodiment of the present invention, the SECS communication device is suitable for installation in a semiconductor equipment having an information storage device or a host having the information storage device, so as to provide the SECS communication function between the equipment and the host.

The present invention provides a SECS communication device. According to an embodiment of the present invention, the SECS communication device comprises a SECS-II message communication part, a configuration file, a translation part, and an information storage device access part. The SECS-II message communication part is responsible for receiving and sending a SECS-II message. The configuration file comprises at least one set of data structure files and a message format file for defining a content and a format of the SECS-II message. The translation part decodes the SECS-II message into data conforming to an information storage format of an information storage device according to the content and the format of the SECS-II message defined by the data structure file and the message format file, and encodes the data stored in the information storage device into the SECS-II message. The information storage device access part is responsible for accessing data from the information storage device.

According to an embodiment of the present invention, the data structure file is used for defining the content of the SECS-II message, and comprises a plurality of fields: Index, Stream, Function, SECS-II Message Name, Tag Name, Tag Index, Information Storage Location, Data Length, SECS-II Data Type, End Item Bit, and Event Data Address/Trigger Address.

According to an embodiment of the present invention, the data structure file may be more than one file, and is responsible for defining contents and identifiers as well as information storage locations of all SECS-II messages that may be received and sent.

According to an embodiment of the present invention, the message format file defines the message format of the SECS-II message by using a unified message format according to SECS communication specification documents, and is connected in series to the data structure file, so as to allow the translation part to perform encoding and decoding process of SECS-II message according to the content and the format of the SECS-II message defined by the data structure file and the message format file.

According to an embodiment of the present invention, the configuration file comprises a first data structure file, a second data structure file, and a message format file. The first data structure file defines a content of a SECS-II message received by the SECS-II message communication part, and the second data structure file defines a content of a SECS-II message sent by the SECS-II message communication part.

The present invention further provides a SECS communication method, suitable for translating a SECS-II message and writing the translated SECS-II message into an information storage device. The SECS communication method comprises: creating a configuration file, in which the configuration file has at least one set of data structure files and a message format file for defining a content and a format of the SECS-II message; decoding a first SECS-II message into a first data message conforming to an information storage format of the information storage device according to the content and the format of the SECS-II message defined by the data structure file and the message format file; and writing the decoded first data message into the information storage device.

According to an embodiment of the present invention, the SECS communication method further comprises the following steps: encoding a second data message stored in the information storage device into a second SECS-II message according to the content and the format of the SECS-II message defined by the data structure file and the message format file; and sending out the encoded second SECS-II message.

In the SECS communication device and the SECS communication method according to the present invention, a configuration file formed by serial connection of a data structure file and a message format file is provided, so that the research and development personnel only need to set the configuration file according to SECS communication specification documents provided by the customer, and after the setting, the equipment has the SECS communication function meeting the requirements of the customer.

In the SECS communication device and the SECS communication method according to the present invention, the system stability is high, the setting and operation modes are intuitive and simple, and compared with the conventional mode of using program code writing, advantages such as low cost and high industrial efficiency are further provided.

### BRIEF DESCRIPTION OF THE DRAWINGS

The present invention will become more fully understood from the detailed description given herein below for illustration only, and thus are not limitative of the present invention, and wherein:

FIG. 1 is a system application architectural view of a SECS communication device of SECS according to an embodiment of the present invention;

FIG. 2 is a system application architectural view of a data structure file in FIG. 1 having more than one file;

FIGS. 3A and 3B are respectively schematic views of a first data structure file and a second data structure file according to the embodiment of the present invention;

FIGS. 4A and 4B are respectively schematic system architectural views of the SECS communication device according to the embodiment of the present invention when receiving a SECS-II message and sending a SECS-II message;

FIG. 5 is a system application architectural view of a SECS communication device of SECS according to another embodiment of the present invention;

FIG. 6A is a flow chart illustrating the steps of a SECS communication method of SECS according to an embodiment of the present invention; and

FIG. 6B is a flow chart illustrating the steps of another embodiment of the SECS communication method in FIG. 6A.

### DETAILED DESCRIPTION OF THE INVENTION

The detailed features and advantages of the present invention are described below in great detail through the following embodiments, and the content of the detailed description is sufficient for those skilled in the art to understand the technical content of the present invention and to implement the present invention accordingly. Based upon the content of the specification, the claims, and the drawings, those skilled in the art can easily understand the relevant objectives and advantages of the present invention.

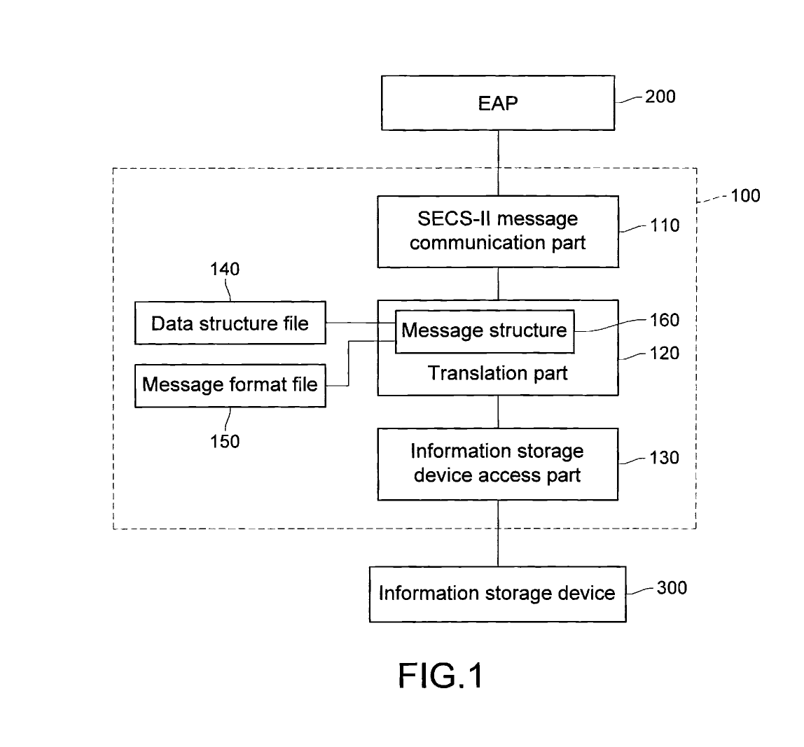

FIG. 1 is a system application architectural view of a SECS communication device according to an embodiment of the present invention. A SECS communication device 100 according to the present invention is applicable to SECS-II message exchange between an equipment automatic program (EAP) 200 and an information storage device 300, in which SECS-II is defined as a SECS message.

The information storage device 300 may be, but is not limited to, one of a programmable logic controller (PLC) server or database server and an object linking and embedding (OLE) for process control (OPC) server or database server. The application of the SECS communication device 100 is not thus limited. In other embodiments of the present invention, the SECS communication device 100 may also be installed in a semiconductor equipment having an information storage device or a host having the information storage device, for example, a personal computer, a tablet computer, a portable computer equipment, or an embedded system, so as to enable the equipment to have the communication function conforming to the SECS-II communication specifications. For ease of detailed illustration, the application of the SECS communication device 100 in SECS-II message exchange between the EAP 200 and the information storage device 300 is hereinafter taken as a preferred embodiment of the present invention for illustration.

The SECS communication device 100 comprises a SECS-II message communication part 110, a translation part 120, an information storage device access part 130, and a configuration file. The configuration file has at least one data structure file 140 and a message format file 150, respectively for defining a content and a format of a SECS-II message.

The SECS-II message communication part 110 is electrically connected to the EAP 200, and is suitable for receiving a SECS-II message form and sending a SECS-II message to the EAP 200. The translation part 120 establishes an electrical signals connection with the SECS-II message communication part 110, the information storage device access part 130, the data structure file 140, and the message format file 150, and may perform combination and serial connection according to the content and the format of the SECS-II message defined by the data structure file 140 and the message format file 150, so as to form a message structure 160 corresponding to the SECS-II message. The data structure file 140 may comprise one or more files to define the message content of the SECS-II message. The message format file 150 is responsible for defining the message format of the SECS-II message according to SECS communication specification documents. For example, the message format file 150 may set the message format of the SECS message according to a unified message format, for example, a SECS Message Language (or referred to as an SML format), so as to be connected in series to the data structure file 140 to define the content and the format of the SECS-II message, and together form the message structure 160 corresponding to the SECS-II message.

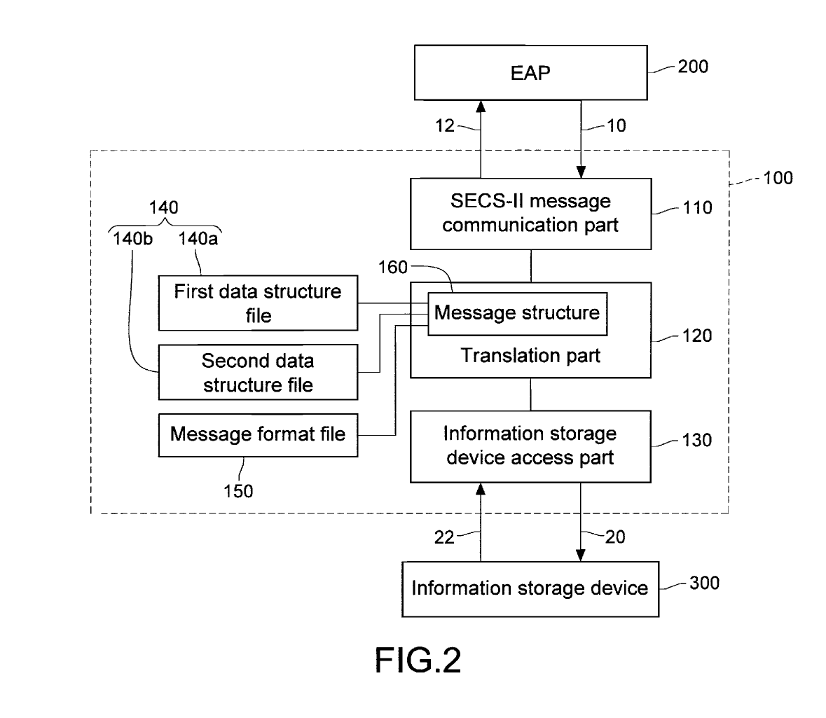

FIG. 2 is a system application architectural view of the data structure file in FIG. 1 having more than one file. As shown in FIG. 2, the data structure file 140 comprises a first data structure file 140a and a second data structure file 140b. When the SECS-II message communication part 110 receives a first SECS-II message 10 sent out from the EAP 200, the translation part 120 decodes the first SECS-II message 10 into a first data message 20 according to a content and a format of the SECS-II message defined by the first data structure file 140a and the message format file 150, and then the information storage device access part 130 can write the first data message 20 into the information storage device 300.

When the information storage device 300 sends out a second data message 22, the translation part 120 may also encode the second data message 22 into a second SECS-II message 12 according to a content and a format of the SECS-II message defined by the second data structure file 140b and the message format file 150, and then the SECS-II message communication part 110 can send the second SECS-II message 12 to the EAP 200.

When the SECS-II message communication part 110 receives the first SECS-II message 10 sent out from the EAP 200, the first data structure file 140a defines the message content of the first SECS-II message 10; and when the SECS-II message communication part 110 sends out the second SECS-II message 12, the second data structure file 140b is used for defining the message content of the second SECS-II message 12.

In particular, the first data structure file 140a and the second data structure file 140b are mainly used for respectively defining a content of a SECS-II message that may be received by the SECS communication device 100 and a content of a SECS-II message that may be transferred by the SECS communication device 100, as shown in the following tables respectively:

| Index [symbol] | Stream [symbol] | Function [symbol] | Message Name [symbol] | Tag Index [symbol] | Tag Name [symbol] | Data Address [symbol] |
|---|---|---|---|---|---|---|
| 3 | 1 | 79 | Request_Online | 0 | CMDCD | D7051 |

| Data | | End Item | Event Data Address/ |
|---|---|---|---|
| Length [symbol] | Data Type [symbol] | Bit [symbol] | Trigger Address [symbol] |
| 1 | BINARY_TYPE | 1 D7003 | |

| Index [symbol] | Stream [symbol] | Function [symbol] | Event Data Address/Trigger Address [symbol] | Message Name [symbol] | Tag Index [symbol] | Tag Name [symbol] |
|---|---|---|---|---|---|---|
| 3 | 1 | 80 | D8003 | EQ_Online_Rpy | 0 | GRANT_S1F80x |

| | | | End Item |
|---|---|---|---|
| Data Address [symbol] | Data Length [symbol] | Data Type [symbol] | Bit [symbol] |
| D8062 | 1 | BINARY_TYPE | 1 |

They respectively have the following fields: Index, Stream, Function, SECS-II Message Name, Tag Index, Tag Name, Data Address, Data Length, SECS-II Data Type, End Item Bit, and Event Data Address/Trigger Address. The Event Data Address/Trigger Address in the first data structure file 140a and the Event Data Address/Trigger Address in the second data structure file 140b are respectively used for defining a location to which data is written and a location from which data is read.

According to the embodiment of the present invention, the Data Address of the first data structure file 140a is used for defining an information storage location in an information storage area to which data of a SECS-II message after being decoded is written. Upon change of data stored at the Event Data Address/Trigger Address of the first data structure file 140a and the second data structure file 140b, the equipment is notified to trigger an action of receiving or sending a SECS-II message respectively. Usually, an event trigger procedure in the equipment defines events that can be used to trigger the action of receiving or sending a SECS-II message.

The message format file 150 is shown as follows, and is used for defining a message format of the SECS-II message:

Reguest_Online:S1F79W
<B[1]tag=CMDCD>
EQ_Online Rpy:S1F80
<B[1]tag=GRANT_S1F80>

Further, the message format file 150 may be combined with the Message Name of the first data structure file 140a and the Message Name of the second data structure file 140b, so as to form by serial connection the message structure 160 corresponding to the SECS-II message. The field association is as follows. The Message Name is used for combining two associated messages, for example, the “Request Online” and “EQ_Online_Rpy” in the message format file 150; the Index is used for combing two associated data structure files 140, and if only one data structure file 140 exists, the Index is still assigned with an index value, but another data structure file 140 having the same index value will not be found; and the Tag Name is used for combining associated fields in two associated data structure files 140.

Continuing with the embodiment of the present invention, the Index of the first data structure file 140a and the Index of the second data structure file 140b are used to match each other for use in correspondence to the first SECS-II message 10 and the second SECS-II message 12. The Stream and Function fields of the first data structure file 140a and the second data structure file 140b respectively correspond to the Stream and Function parts of the first SECS-II message 10 and the second SECS-II message 12. The SECS-II Message Name of the first data structure file 140a and the SECS-II Message Name of the second data structure file 140b respectively define message tags of the first SECS-II message 10 received by the SECS communication device 100 and the second SECS-II message 12 sent by the SECS communication device 100. The Tag Name of the first data structure file 140a and the Tag Name of the second data structure file 140b are respectively responsible for defining identification tags of an item of the first SECS-II message 10 and an item of the second SECS-II message 12 (for example, B[1] tag=CMDCD in the message format file 150). The Tag Index of the first data structure file 140a and the Tag Index of the second data structure file 140b are respectively responsible for defining identification tag index values of an item of the first SECS-II message 10 and an item of the second SECS-II message 12. For example, when the item actually has a plurality of tag index values (for example, a cassette has 25 wafers), the Tag Index may be defined from 0 to 24.

The Data Address of the first data structure file 140a and the Data Address of the second data structure file 140b mainly respectively define a storage location in the corresponding storage area of the information storage device to which the first SECS-II message 10 is written and a storage location in the corresponding storage area of the information storage device from which information is read corresponding to the second SECS-II message 12. The Data Length of the first data structure file 140a and the Data Length of the second data structure file 140b are respectively used for defining data lengths of the item of the first SECS-II message 10 and the item of the second SECS-II message 12. The SECS-II Data Type of the first data structure file 140a and the SECS-II Data Type of the second data structure file 140b are respectively used for defining SECS-II data types of the item of the first SECS-II message 10 and the item of the second SECS-II message 12. Their respective End Item Bit is respectively used for determining whether a flag indicating Completed has been set for message items of the first SECS-II message 10 and the second SECS-II message 12. Finally, the Event Data Address/Trigger Address of the first data structure file 140a and the Event Data

Address/Trigger Address of the second data structure file 140b respectively define the storage location in the corresponding storage area of the information storage device to which the first SECS-II message 10 drives the SECS communication device 100 to write and the storage location in the corresponding storage area of the information storage device to which the SECS communication device 100 drives to send the second SECS-II message 12.

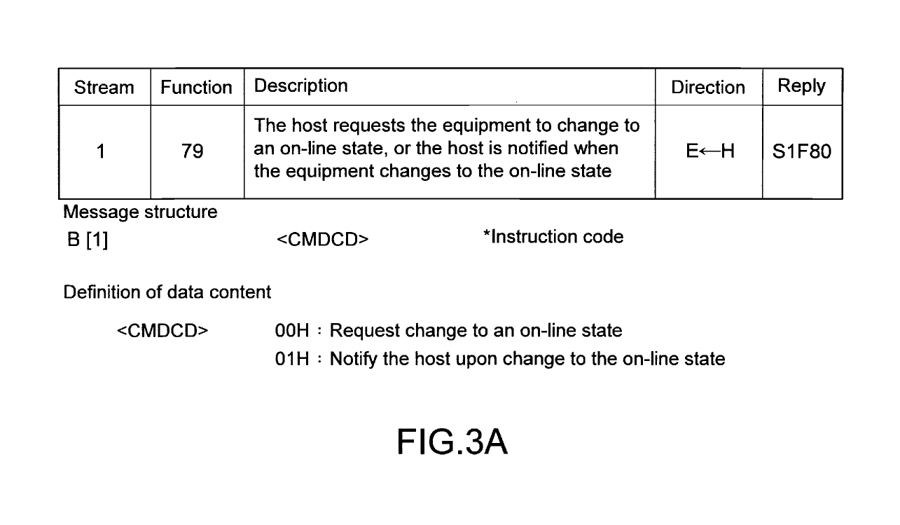

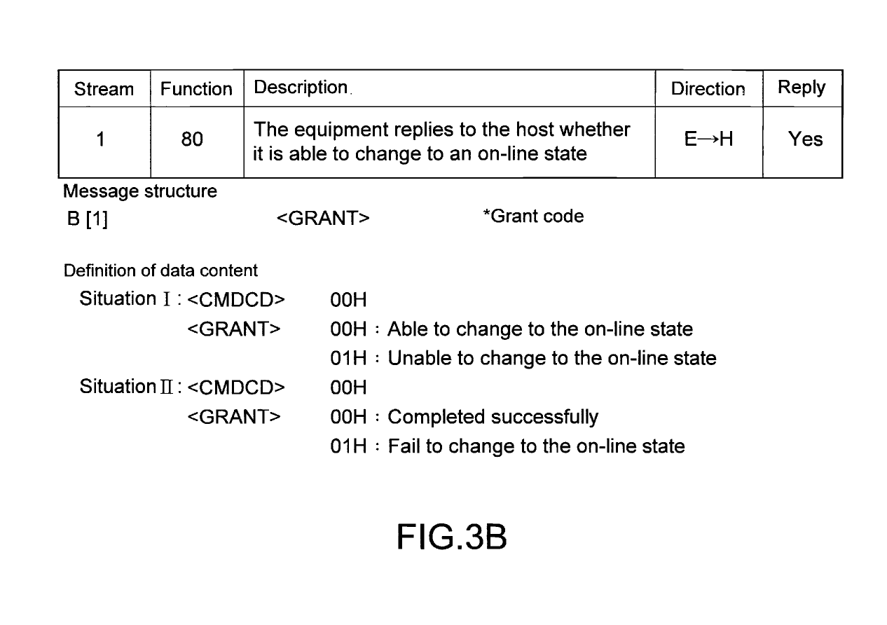

FIGS. 3A and 3B are respectively schematic views of the first data structure file and the second data structure file according to the embodiment of the present invention. The first data structure file 140a and the second data structure file 140b respectively comprise fields such as Index, Stream, Function, SECS-II Message Name, SECS-II Data Type, Tag Name, Tag Index, Data Length, and End Item Bit, so as to respectively define message contents of the first SECS-II message 10 received by the SECS communication device 100 and the second SECS-II message 12 sent by the SECS communication device 100.

As shown in FIG. 3A, when the direction of the first data structure file 140a is defined as E←H, it represents that the second data message 22 sent out from the host is subjected to an encoding procedure, and becomes the first SECS-II message 10 received by the equipment, in which the data content may be self-defined by a user. For example, when an instruction code is OOH, the host may request the equipment to change to an on-line state; and when the instruction code is 01H, it is defined that the host is notified when the equipment changes to the on-line state.

As shown in FIG. 3B, when the direction of the second data structure file 140b is defined as E→H, it represents that the second data message 22 sent out from the equipment is subjected to a decoding procedure, and becomes the first SECS-II message 10 received by the host, in which the data content similarly can be self-defined by the user. For example, when an instruction code and a grant code are both 00H, the equipment replies to the host that it is able to change to an on-line state; and when the instruction code is 00H and the grant code is 01H, the equipment replies to the host that it fails to change to an on-line state. The above definition of the data content is merely an example given to explain the technique of the present invention, but is not intended to limit the scope of the present invention. Therefore, the designer may self-define or modify the message contents of the first data structure file 140a and the second data structure file 140b according to specs and communication specifications provided by the customer, and define the content and the format of the SECS-II message after combination and connection of the first data structure file 140a and the second data structure file 140b with the message format file 150, so as to form the message structure 160 conforming to the communication specifications of the SECS-II message.

It should be noted that, the first data structure file 140a and the second data structure file 140b may be selectively combined into the same data structure file, and differentiated by adding fields in the file or being divided as different blocks in the file.

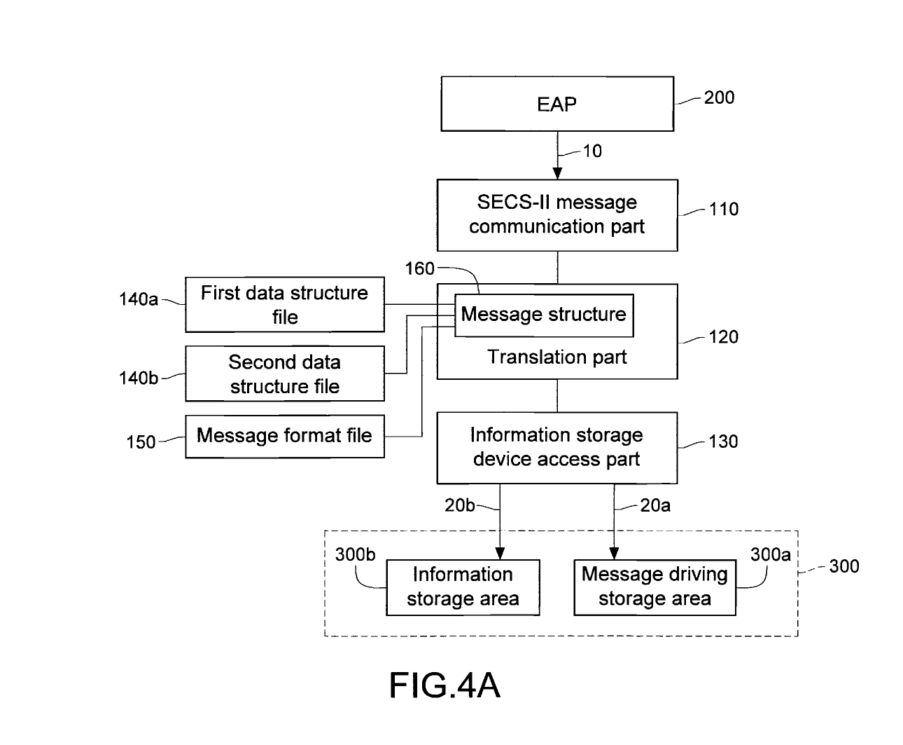

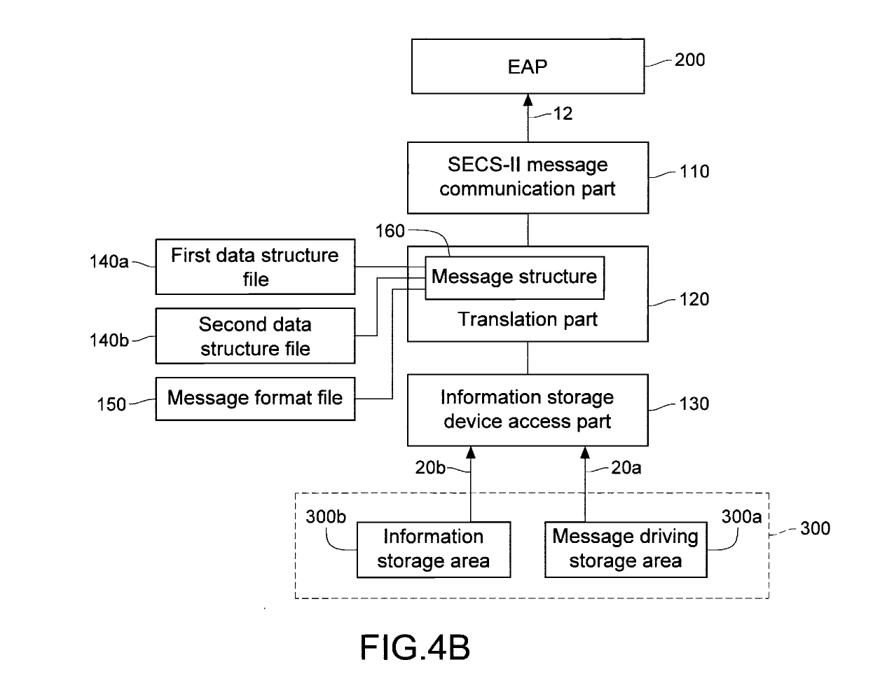

The reception and sending of a SECS-II message by the SECS communication device 100 will be illustrated in detail below with reference to FIGS. 4A and 4B. FIGS. 4A and 4B are respectively schematic system architectural views of the SECS communication device according to the embodiment of the present invention when receiving a SECS-II message and sending a SECS-II message. As shown in FIG. 4A, when the SECS-II message communication part 110 receives the first SECS-II message 10, the translation part 120 firstly decodes the first SECS-II message 10 into the first data message 20 according to the content and the format of the SECS-II message defined by the first data structure file 140a and the message format file 150. The first data message 20 comprises a driving signal 20a and a data content 20b. The data content 20b is transferred and temporarily stored in an information storage area 300b in the information storage device 300 first. The driving signal 20a is used for changing a storage value of a message driving storage area 300a in the information storage device 300 before receiving the first data message 20. Therefore, after the storage value is changed by the driving signal 20a, the information storage device 300 reads the data content 20b of the first data message 20 temporarily stored in the information storage area 300b in advance. Till now, the step of decoding the first SECS-II message 10 into the first data message 20, and writing the first data message 20 into the information storage device 300 has been completed.

Referring to FIG. 4B, when the information storage device 300 sends out the second data message 22, the second data message 22 also comprises a driving signal 22a and a data content 22b. The data content 22b is similarly transferred and temporarily stored in the information storage area 300b first, and the driving signal 22a is used for changing a storage value of the message driving storage area 300a before sending out the second data message 22. Therefore, after the storage value is changed by the driving signal 22a, the information storage device access part 130 reads the data content 22b of the second data message 22 temporarily stored in the information storage area 300b in advance. Afterwards, the translation part 120 can encode the second data message 22 into the second SECS-II message 12 according to the content and the format of the SECS-II message defined by the second data structure file 140b and the message format file 150. The SECS-II message communication part 110 then can send the second SECS-II message 12 to the EAP 200. Till now, the step of encoding the second data message 22 into the second SECS-II message 12, and sending the second SECS-II message 12 to the EAP 200 has been completed.

According to the embodiment of the present invention, the SECS-II message communication part 110, the translation part 120, and the information storage device access part 130 may be functions implemented by software program codes. That is to say, the SECS communication device 100 according to the embodiment of the present invention per se is a SECS communication application having extensibility.

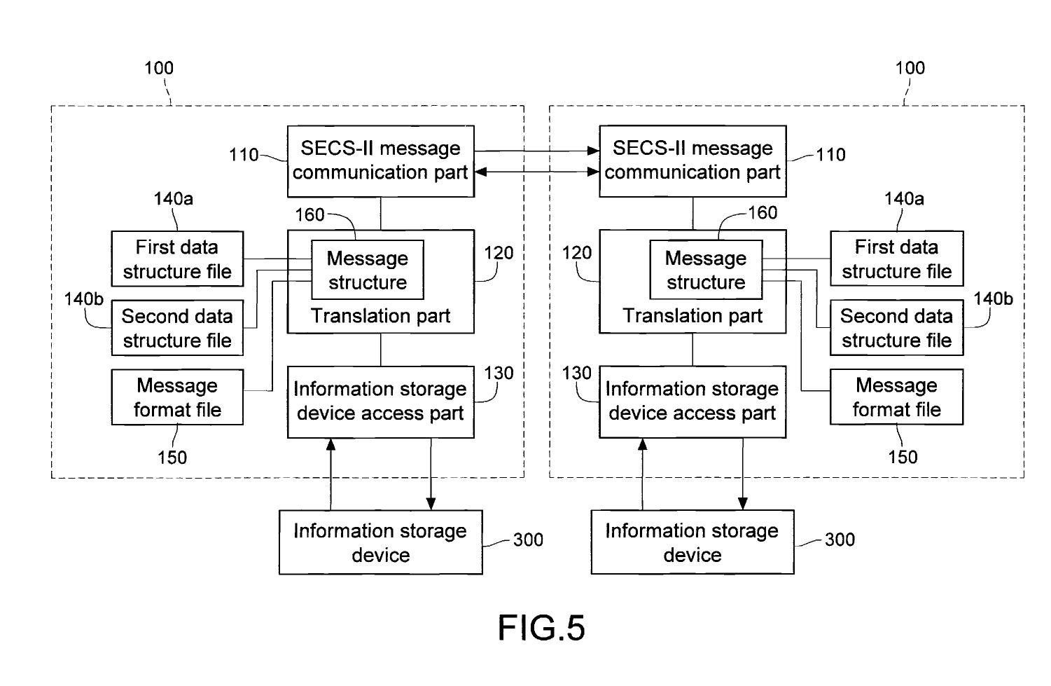

FIG. 5 is a system application architectural view of a SECS communication device according to another embodiment of the present invention. As shown in FIG. 5, the SECS communication device 100 is not limited to being applied in the SECS-II message exchange between the EAP and the information storage device 300, and the SECS communication device 100 may also be applied in the SECS-II message exchange between various levels of the SECS communication device 100. That is to say, according to another embodiment of the present invention, the SECS-II message compiled by the translation part 120 is not limited to being sent to the semiconductor equipment (for example, the EAP), and it may also be sent to another host having the information storage device 300.

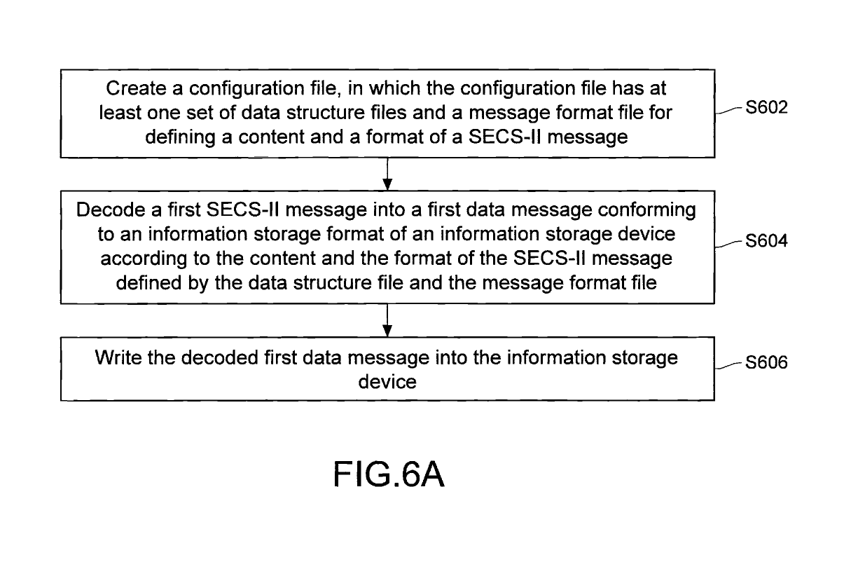

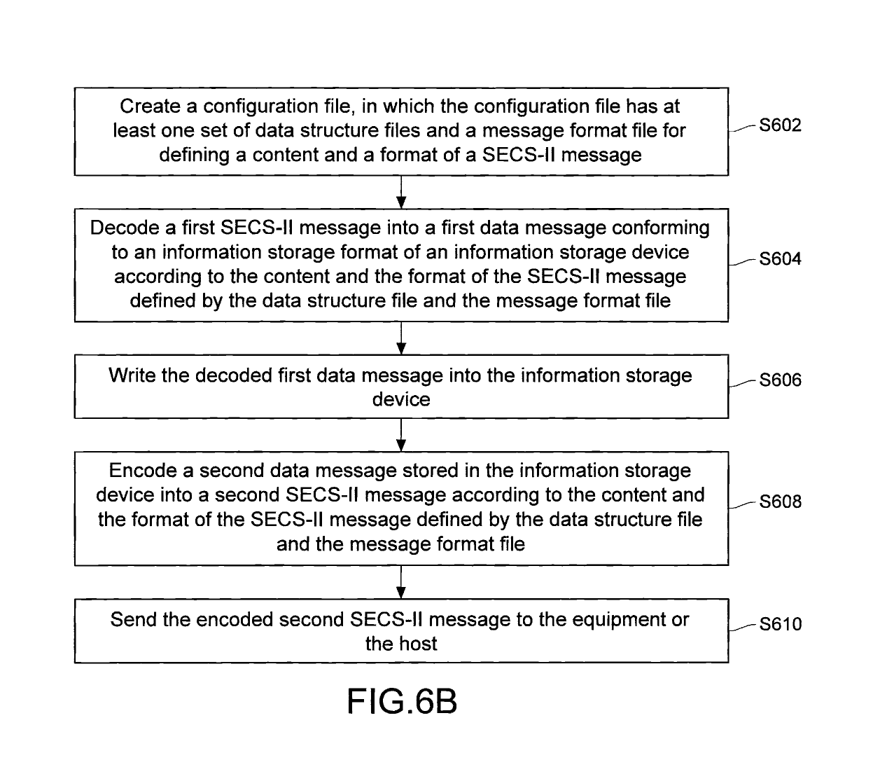

FIG. 6A is a flow chart illustrating the steps of a SECS communication method according to an embodiment of the present invention. The SECS communication method is applicable to the aforementioned SECS communication device 100, so as to be installed in a semiconductor equipment having an information storage device or a host having the information storage device (for example, a personal computer, a tablet computer, a portable computer equipment, or an embedded system), thereby enabling the equipment to have the communication function conforming to the SECS-II communication specifications. The SECS communication method is also applicable to SECS-II message exchange between an EAP and an information storage device (for example, an OPC or PLC database server). The application of the SECS communication method to the aforementioned SECS communication device 100 is hereinafter taken as an embodiment of the present invention for illustration, but the application thereof is not thus limited.

Referring to FIGS. 2 and 6A, the SECS communication method according to the present invention comprises Steps S602 to S606.

In Step S602, a configuration file is created, in which the configuration file has at least one set of data structure files 140 and a message format file 150 for defining a content and a format of a SECS-II message.

In Step S604, a first SECS-II message 10 is decoded into a first data message 20 conforming to an information storage format of an information storage device 300 according to the content and the format of the SECS-II message defined by the data structure file 140 and the message format file 150.

In Step S606, the decoded first data message 20 is written into the information storage device 300.

According to an embodiment of the present invention, the data structure file 140 may comprise a first data structure file 140a for defining a message content of the first SECS-II message 10 received by the SECS communication device 100. The message format file 150 sets a message format of the first SECS-II message 10 according to a unified message format, for example, the SECS Message Language (or referred to as an SML format). The data structure file 140 and the message format file 150 define by serial connection the content and the format of the SECS-II message. Then, the procedure of decoding the first SECS-II message 10 into the first data message 20 and writing the first data message 20 into the information storage device 300 in Steps S604 to S606 is the same as that in the illustration of the embodiment of the SECS communication device 100 in FIG. 4A of the present invention, and thus is not repeated herein.

FIG. 6B is a flow chart illustrating the steps of another embodiment of the SECS communication method in FIG. 6A, which comprises Steps S602 to S606 as well as Steps S608 and S610.

In Step S608, a second data message 22 stored in the information storage device 300 is encoded into a second SECS-II message 12 according to the content and the format of the SECS-II message defined by the data structure file 140 and the message format file 150.

In Step S610, the encoded second SECS-II message 12 is sent to the equipment or the host.

According to an embodiment of the present invention, the data structure file 140 may further comprise a second data structure file 140b for defining a message content of the second SECS-II message 12 sent by the SECS communication device 100, so as to be connected in series to the message format file 150 to define the content and the format of the SECS-II message. Then, the procedure of encoding the second data message 22 into the second SECS-II message 12 and sending the second SECS-II message 12 to the equipment (for example, the EAP) or the host in Steps S608 to S610 is the same as that in the illustration of the embodiment of the SECS communication device 100 in FIG. 4B of the present invention, and thus is not repeated herein.

Based on the above, in the SECS communication device according to the present invention, upon start-up of the SECS communication device, the translation part can load a data structure file and a message format file meeting the requirements of the customer, thereby defining by serial connection a content and a format of a SECS-II message. Thus, the SECS communication device has the SECS communication function meeting the requirements of the customer.

Secondly, in the SECS communication method according to the present invention, the user can directly modify a data structure file and a message format file, so that the SECS communication device immediately has the SECS communication function meeting the requirements of the customer without re-writing system program codes.

In view of the above, in the SECS communication device and the SECS communication method according to the present invention, the system stability is high, the setting and operation modes are intuitive and simple, and compared with the conventional mode of using program code writing, advantages such as low cost, high industrial efficiency, and reduced introduction time and cost are further provided.

What is claimed is:

1. A SEMI Equipment Communication Standards (SECS) communication device, suitable for installation in a semiconductor equipment having an information storage device or a host having the information storage device, so as to provide a SECS communication function between the semiconductor equipment having the information storage device and the host having the information storage device, the SECS communication device comprising:
a SECS-II message communication part, for receiving and sending a SECS-II message;
a configuration file, having at least one set of data structure files and a message format file for defining a content and a format of the SECS-II message;
a translation part, for encoding the SECS-II message into data in an information storage format of the information storage device according to the content and the format of the SECS-II message defined by the data structure file and the message format file, and encoding the data in the information storage format of the information storage device into the SECS-II message; and
an information storage device access part, for establishing an electrical signals connection with the translation part, wherein
the information storage device access part is used for accessing data from the information storage device.

2. The SECS communication device according to claim 1, wherein the message format file defines the message format of the SECS-II message by using a unified message format according to SECS communication specification documents.

3. The SECS communication device according to claim 2, wherein the data structure file comprises a plurality of fields: Index, Stream, Function, SECS-II Message Name, Tag Name, Tag Index, Information Storage Location, Data Length, SECS-II Data Type, End Item Bit, and Event Data Address/Trigger Address, and the message format file defines the message format of the SECS-II message, and is connected in series to the Message Name of the data structure file, so as to allow the translation part to perform encoding and decoding process of SECS-II message.

4. The SECS communication device according to claim 1, wherein the data structure file comprises a first data structure file, and when the SECS-II message communication part receives a first SECS-II message, the translation part decodes the first SECS-II message into a first data message according to the content and the format of the SECS-II message defined by the data structure file and the message format file, and the information storage device access part writes the first data message into the information storage device.

5. The SECS communication device according to claim 4, wherein the first data structure file defines a message content of the first SECS-II message received by the SECS-II message communication part.

6. The SECS communication device according to claim 4, wherein the first data message comprises a driving signal and a data content, the driving signal is used for changing a storage value of the information storage device before receiving the first data message, and after the storage value is changed, the information storage device reads the data content of the first data message output from the information storage device access part.

7. The SECS communication device according to claim 1, wherein the data structure file comprises a second data structure file, and when the information storage device sends out a second data message, the translation part encodes the second data message into a second SECS-II message according to the content and the format of the SECS-II message defined by the data structure file and the message format file, and the SECS-II message communication part sends the second SECS-II message to the semiconductor equipment having the information storage device or the host having the information storage device.

8. The SECS communication device according to claim 7, wherein the second data structure file defines a message content of the second SECS-II message sent by the SECS-II message communication part.

9. The SECS communication device according to claim 7, wherein the second data message comprises a driving signal and a data content, the driving signal is used for changing a storage value of the information storage device before sending out the second data message, and after the storage value is changed, the information storage device access part reads the data content of the second data message sent out from the information storage device.

10. The SECS communication device according to claim 1, wherein the information storage device is one of a programmable logic controller (PLC) server or database server and an object linking and embedding (OLE) for process control (OPC) server or database server.

11. A SEMI Equipment Communication Standards (SECS) communication method, suitable for installation in a semiconductor equipment having an information storage device or a host having the information storage device, so as to provide a SECS communication function between the semiconductor equipment having the information storage device and the host having the information storage device, the SECS communication method comprising:
creating a configuration file, wherein the configuration file has at least one set of data structure files and a message format file for defining a content and a format of a SECS-II message;
decoding a first SECS-II message into a first data message conforming to an information storage format of the information storage device according to the content and the format of the SECS-II message defined by the data structure file and the message format file; and
writing the decoded first data message into the information storage device.

12. The SECS communication method according to claim 11, further comprising:
encoding a second data message stored in the information storage device into a second SECS-II message according to the content and the format of the SECS-II message defined by the data structure file and the message format file; and
sending the encoded second SECS-II message to the semiconductor equipment having the information storage device or the host having the information storage device.

13. The SECS communication method according to claim 12, wherein the message format file defines message formats of the first SECS-II message and the second SECS-II message by using a unified message format according to SECS communication specification documents.

14. The SECS communication method according to claim 12, wherein the data structure file comprises a plurality of fields: Index, Stream, Function, SECS-II Message Name, Tag Name, Tag Index, Information Storage Location, Data Length, SECS-II Data Type, End Item Bit, and Event Data Address/Trigger Address, and the message format file defines the message format of the SECS-II message, and is connected in series to the Message Name of the data structure file, so as to allow encoding and decoding process of SECS-II message.

15. The SECS communication method according to claim 12, wherein the data structure file comprises a first data structure file and a second data structure file, the first data structure file defines a message content of the first SECS-II message that is received, and the second data structure file defines a message content of the second SECS-II message that is sent.

16. The SECS communication method according to claim 12, wherein the second data message comprises a driving signal and a data content, the driving signal is used for changing a storage value of the information storage device before sending out the second data message, and after the storage value is changed, the semiconductor equipment having the information storage device or the host having the information storage device receives the data content of the second data message sent out from the information storage device.

17. The SECS communication method according to claim 11, wherein the first data message comprises a driving signal and a data content, the driving signal is used for changing a storage value of the information storage device before receiving the first data message, and after the storage value is changed, the information storage device reads the data content of the first data message.

18. The SECS communication method according to claim 11, wherein the information storage device is one of a programmable logic controller (PLC) server or database server and an object linking and embedding (OLE) for process control (OPC) server or database server.
